(19) United States
(12) Patent Application Publication
(10) Pub. No.: US 2009/0129448 A1
(43) Pub. Date: May 21, 2009

(54) Apparatus and Method For Generating Scrambling Codes

(76) Inventors: Joshua Lawrence Koslov, Hopewell, NJ (US); Wen Gao, West Windsor, NJ (US)

Correspondence Address: Robert D. Shedd;Thomson Licensing LLC, PO Box 5312, PRINCETON, NJ, 08543-5312, US

(21) Appl. No.: 12/087,817

(22) PCT Filed: Jan. 15, 2006
(86) PCT No.: PCT/US2006/005193

§ 371 Date: Jul. 14, 2008

(51) Int. Cl. H04B 1/707; H04B 7/216; H04J 13/00

(52) U.S. Cl. 375/148; 375/147; 370/342; 375/E01.032

(57) ABSTRACT

A wireless WCDMA (wideband code division multiple access) receiver comprises a plurality of fingers, a mask engine, a plurality of delay mask scrambling code generators and a maximal ratio combiner. Each finger process a path of a received multi-path signal having an associated delay. For each of the delays, the mask engine provides a corresponding delay mask to a delay mask scrambling code generator, which then provides a scrambling code with the appropriate offset, or delay, to the requisite finger. Output signals from the fingers are provided to the maximal ratio combiner.

### BACKGROUND OF THE INVENTION

The present invention generally relates to a receiver architecture for use with Code Division Multiple Access (CDMA) and spread spectrum wireless networks.

CDMA refers to any of several protocols used in so-called second-generation (2G) and third-generation (3G) wireless communications. CDMA is a form of multiplexing that allows numerous signals (channels) to occupy a single physical transmission channel, thereby optimizing bandwidth. These signals are transmitted using the same frequency band and are differentiated by transmitting each signal using a different spreading code. In particular, the spreading codes are used to separate individual signals transmitted from a given base station. In like fashion, scrambling codes allow signals from different base stations to be differentiated from one another. Accordingly, all signals transmitted from a particular base station are scrambled using the same scrambling code. For example, in the Universal Mobile Telecommunications System (UMTS), a scrambling code covers a UMTS frame (38,400 chips) and comprises 38,400 chip values.

In practice, multiple delayed versions of the transmitted signal arrive at a CDMA receiver. For example, one version of the signal may arrive by traveling a direct path from a base station to the CDMA receiver, while another version may arrive later because the signal reflected off of a building before its arrival. As such, the received signal is also known as a multipath signal and contains multiple delayed versions of the transmitted signal. Each version of the transmitted signal is known as a path.

In CDMA, this multipath interference is combated by constructively adding outputs of fingers in a rake receiver to form a combined signal. This is illustrated in FIG. 1, which shows a portion of a 3G Wideband (W) CDMA receiver 100. For purposes of illustration, only two fingers have been depicted in FIG. 1. As known in the art, a searcher (not shown) processes a received multipath signal (101) to first identify the various paths contained therein and their associated delays by correlating received samples against different offsets of the scrambling code. Notably, the scrambling code is previously identified by the WCDMA receiver during the known cell search operation and stored in scrambling code memory 170. Once the individual paths and their associated delays are determined, each of the fingers 105 and 125 is assigned to process a particular path of the multipath signal by using the relevant portion of the scrambling code (i.e., with the appropriate offset, or delay). As such, each finger requires a delayed version of the scrambling code, corresponding to the delay of the path to which it is assigned. As shown in FIG. 1, the relevant portion of the scrambling code (171, 172) is provided by, e.g., using a different pointer into scrambling code memory 170. The resulting signals provided by each finger are then aligned in time via delays 145 and 150 and processed by maximal ratio combiner (MRC) 155, which provides combined signal 156 for subsequent processing.

Another alternative arrangement 190 is shown in FIG. 2. This arrangement is similar to that shown in FIG. 1 except that each finger has an associated scrambling code generator for generating the required portion of the scrambling code. Often, each scrambling code generator is implemented using a linear feedback shift register (LFSR) architecture. Accordingly, scrambling code generators 110 and 130 require residual generators 120 and 140 respectively for computing initial conditions for each LFSR. Each residual generator is controlled by the searcher element (not shown). Each scrambling code generator also must be linked with a numerically controlled oscillator (NCO) to handle advancing/retarding clock cycles to achieve sub-chip resolution with the scrambling code. Thus, scrambling code generators 110 and 130 are linked with NCOs 115 and 135 respectively.

Unfortunately, the arrangement shown in FIG. 1 requires a large, and fast, memory; while the arrangement shown in FIG. 2 requires a significant amount of hardware (i.e., each finger requires a scrambling code generator, a residual generator, and an NCO).

### SUMMARY OF THE INVENTION

In accordance with the principles of the invention, a receiver comprises a mask engine for providing a delay mask associated with a delay; and a scrambling code generator responsive to the delay mask for providing an offset version of a scrambling code, where the offset corresponds to the delay.

In an illustrative embodiment, a wireless WCDMA (wideband code division multiple access) receiver comprises a plurality of fingers, a mask engine, a plurality of delay mask scrambling code generators and a maximal ratio combiner. Each finger process a path of a received multi-path signal having an associated delay. For each of the delays, the mask engine provides a corresponding delay mask to a delay mask scrambling code generator, which then provides a scrambling code with the appropriate offset, or delay, to the requisite finger. Output signals from the fingers are provided to the maximal ratio combiner.

### BRIEF DESCRIPTION OF THE DRAWINGS

FIGS. 1 and 2 illustrate prior art wireless receivers;

FIG. 3 shows a relationship between scrambling codes in the context of delay masks in accordance with the principles of the invention;

FIG. 4 shows an illustrative pseudo-code implementation for calculating delay masks in accordance with the principles of the invention;

FIGS. 5, 6 and 7 show illustrative hardware implementations for the pseudo-code of FIG. 4;

FIG. 8 shows an illustrative embodiment of a receiver in accordance with the principles of the invention;

FIG. 9 shows an illustrative embodiment of a portion of the receiver of FIG. 8 in accordance with the principles of the invention;

FIG. 10 shows an illustrative flow chart in accordance with the principles of the invention for use in a wireless receiver;

FIG. 11 shows an illustrative embodiment of a delay mask scrambling code generator in accordance with the principles of the invention; and

FIG. 12 shows another illustrative embodiment of a portion of a receiver in accordance with the principles of the invention.

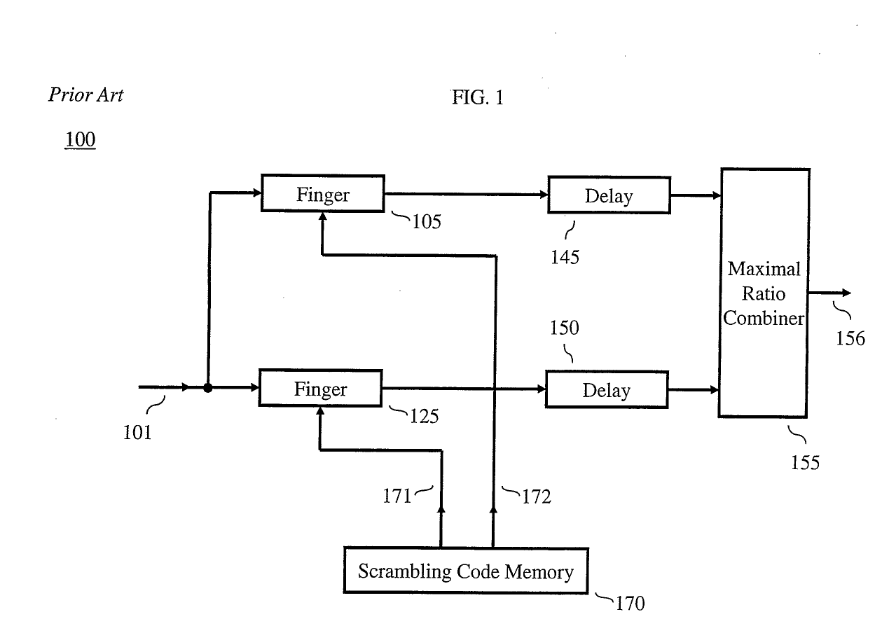

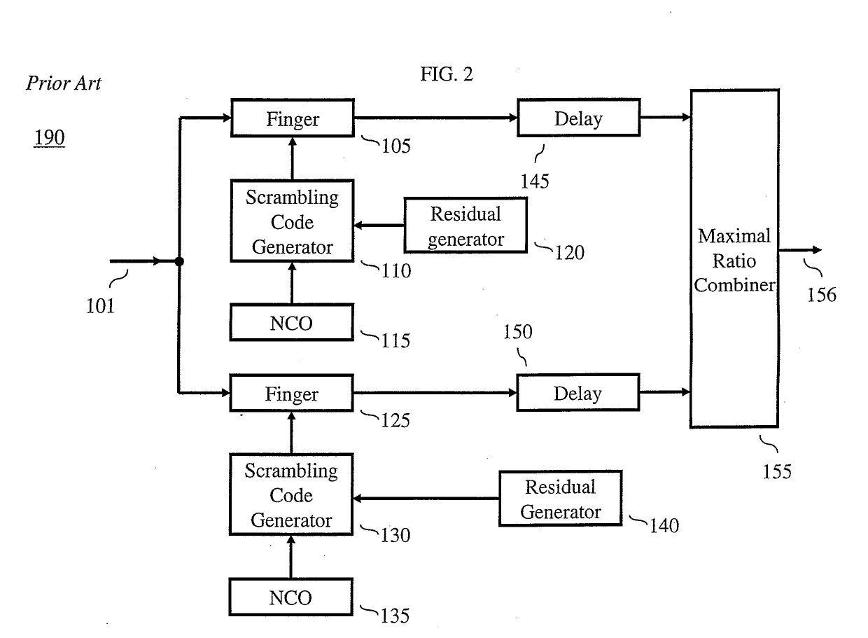

### DETAILED DESCRIPTION

Other than the inventive concept, the elements shown in the figures are well known and will not be described in detail. Also, familiarity with 3GPP (Third Generation Partnership Project) or UMTS-based wireless communications systems is assumed and is not described in detail herein. For example, other than the inventive concept, spread spectrum transmission and reception, cells (base stations), user equipment (UE), downlink channels, uplink channels, the searcher, combiner, PN (pseudo-noise) generators, fingers and RAKE receivers are well known and not described herein. In addition, the inventive concept may be implemented using conventional programming techniques, which, as such, will not be described herein. Finally, like-numbers on the figures represent similar elements.

Before describing the inventive concept, some background information on scrambling codes is presented. In a 3GPP system, complex scrambling codes are generated from two PN (psuedo-noise) sequences x and y that are generated from 18-stage shift registers (also known in the art as linear feedback shift registers (LFSRs)). The initial conditions for the x LFSR and the y LFSR are:

x(0)=1;x(1)= . . . x(17)=0;and (1)

y(0)= . . . y(17)=1. (2)

Recursive definition of subsequent symbols are:

x(i+18)=[x(i+7)+x(i)] mod 2,i=0 . . . 2¹⁸−20;and (3)

y(i+18)=[y(i+10)+y(i+7)+y(i+5)+y(i)] mod 2,i=0 . . . 2¹⁸−20. (4)

For a scrambling code number n, a sequence zₙ is defined as:

zₙ(i)={x[(i+n)mod(2¹⁸−1)]+y(i)} mod 2,i=0, . . . , 2¹⁸−2. (5)

These zₙ sequences are used to create a real valued sequence Zₙ, where

Zₙ(i)=1 for zₙ(i)=0;else−1. (6)

From these Zₙ real valued sequences, the nth complex downlink scrambling code sequence S_{dl,n} (also referred to herein as simply the scrambling code) is generated as:

S_{dl,n}=Zₙ(i)+j Zₙ[(i+131072)mod(2¹⁸−1)],for i=0, . . . , 38399. (7)

The above complex downlink scrambling code sequence S_{dl,n}, can be expanded into real and imaginary parts, where the real part of S_{dl,n}=Zₙ(i) requires:

zₙ(i)={x[(i+n)mod(2¹⁸−1)]+y(i)} mod 2,i=0, . . . , 2¹⁸−2. (8)

And the imaginary part of S_{dl,n}=Zₙ[(i+131072) mod(2¹⁸−1)] requires:

zₙ[(i+131072)mod(2¹⁸−1)]={x[(i+n+131072)mod(2¹⁸−1)]+y[(i+131072)mod(2¹⁸−1)]} mod 2,i=0, . . . , 2¹⁸−2. (9)

In order to incorporate a particular delay into the scrambling code sequence S_{dl,n}, this sequence has to be advanced by an associated number of chips, d. It can be observed from the above equations that the real and imaginary parts have to be generated. For a particular advance of d chips, the real part of S_{dl,n}=Zₙ(i+d) requires:

zₙ(i+d)={x[(i+n+d)mod(2¹⁸−1)]+y[(i+d)mod(2¹⁸−1)]} mod 2,i=0, . . . , 2¹⁸−2. (10)

And the imaginary part of S_{dl,n}=Zₙ [(i+d+131072) mod(2¹⁸−1)] requires:

zₙ[(i+d+131072)mod(2¹⁸−1)]={x[(i+n+131072+d)mod(2¹⁸−−1)]+y[(i+131072+d)mod(2¹⁸−1)]} mod 2,i=0, . . . , 2¹⁸−2. (11)

As a result, for an advance of d chips, the x LFSR is suitably clocked, or advanced, to provide x[(i+n+d) mod (2¹⁸−1)] and x[(i+n+131072+d) mod (2¹⁸−1)]; and the y LFSR is suitably clocked, or advanced, to provide y[(i+d) mod (2¹⁸−1)], and y[(i+131072+d) mod (2¹⁸−1)].

However, and in accordance with the principles of the invention, given an LFSR structure, an arbitrary advance, or delay, d for a particular scrambling code can be alternatively determined by creating a suitable delay mask m_{d}, where:

m_{d}=[m_{d}(0),m_{d}(1), . . . m_{d}(17)]. (12a)

Note that here the delay mask is represented by a vector m_{d}. It can also be represented by the corresponding polynomial, given as

m_{d}(w)=m_{d}(0)+m_{d}(1)w+m_{d}(2)w²+ . . . +m_{d}(17)w¹⁷, (12b)

where w is the independent variable.

In the following description, we may use either the vector form of the delay mask m_{d} or the polynomial form of the delay mask m_{d}(w) based on the context. We may also omit the subscript d for simplification of representation if it is implied from the context.

A scrambling code, S_{dl,n}, with a desired advance d, can be simply determined by using masks to generate appropriately advanced PN sequences, where the PN sequences are taken not from a single stage of a LFSR, but from a binary sum of all the stages of the LFSR as selected by the mask: for example, a LFSR x may provide non-advanced output

x(i)=S(0), (13a)

or, through the use of mask m, provide advanced output

x(i+d)=[S(0)m(0)+ . . . +S(17)m(17)] mod 2, (13b)

where {S[0], S[1], . . . , S[17]} represents the state of the LFSR. In particular, the delay mask, m_{d}, of equation (12a) is a vector of bits having the same length as the PN generator and, in equation (13b), the delay mask is used to select (via a logical bitwise AND operation) bits from the current state of the x PN generator; where the selected bits are then XORed together to produce an output. The output thus generated, one bit per state of the PN generator, represents a delayed version of the normal output of the PN generator taken from the last (or another predefined) stage of the PN generator.

In view of the above, a delay mask for an advance of k is calculated as

mₖ(w)=rem[w^{k},g(w)], (14)

where g(w) is the generator polynomial of the LFSR sequence, and rem represents the remainder after polynomial division. This k can be a very big number; hence, direct calculation via polynomial division becomes impractical.

However, and in accordance with the principles of the invention, an arbitrary advance can be composed of constituent parts, each of which has a corresponding delay mask. That is, k=i+j, and

mₖ(w)=mᵢ₊ⱼ(w)=rem[wⁱ*w^{j},g(w)], (15)

where “*” denotes polynomial multiplication and mᵢ₊ⱼ(w) is the delay mask corresponding to an advance of (i+j). In addition, it is noted that:

rem[wⁱ*w^{j},g(w)]=rem {rem[wⁱ,g(w)]*rem[w^{j},g(w)],g(w)}, or (16)

rem[wⁱ*w^{j},g(w)]=rem [mᵢ(w)*mⱼ(w),g(w)]. (17)

Hence, from the above equations, it is seen that the new delay mask mᵢ₊ⱼ(w), corresponding to an advance (i+j), is a function of the two delay masks corresponding to its constituent advances i and j: namely, delay masks mᵢ(w) and mⱼ(w). Therefore, any desired advance can be decomposed into, e.g., binary advances, 2⁰, 2¹, 2², . . . or other pre-calculated constituent advances.

In the 3GPP system, although the natural repetition of the maximal length shift registers would be of length 2¹⁸−1, the sequences are truncated and repeated with period 38,400 (the length of a radio frame). Hence a delayed version of a sequence requires the use of two different delay masks at different times, as explained below.

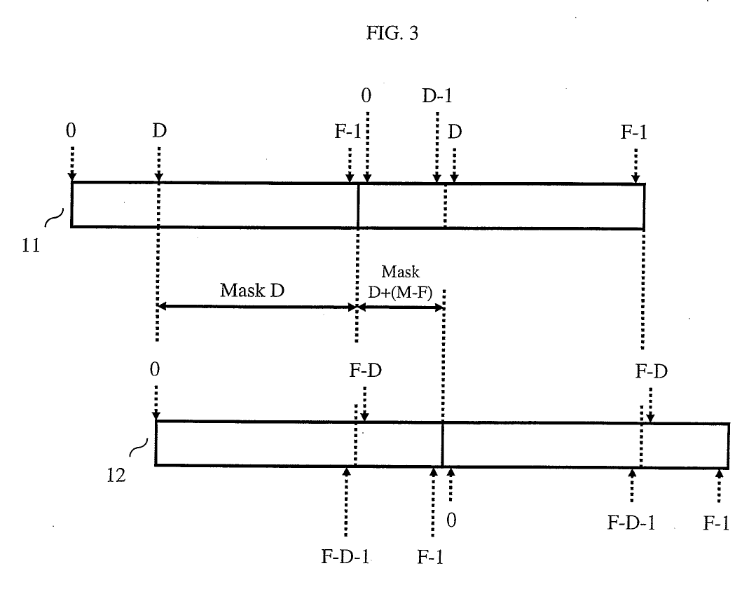

Consider a code created from a PN generator with period M, for example 2¹⁸−1, as in 3GPP; further, consider a shortened repetition period F used with this generator, for example F=38400 corresponding to a 3GPP radio frame. If it is desired to generate a primary code with a zero delay and an advanced version of the code with advance D, it would seem logical to generate the delay mask corresponding to advance D. This is illustrated in FIG. 3. In particular, the relationship between a code 11 (the primary code) and a code 12 (the advanced code) is shown, where the advanced code (12) represents the primary code (11) with an advance of D. At a time 0, the advanced code (12) corresponds to the primary code (11) at 0+D; at a time F−D−1, the advanced code (12) corresponds to the primary code (11) at F−D−1+D or F−1. It should be noted that at time F−D, the advanced code (12) corresponds to the primary code (11) at F−D+D or F. However, because of the truncated sequence, the advanced code (12) must return to the state at time 0, and the required advance is now [−F−D)], which is equivalent (modulo M) to M−(F−D) or D+(M−F) as shown in FIG. 3. Therefore, at those times in the primary code (11) from F−D to F−1, an advance of D+(M−F) is required; while at other times, an advance of D is required.

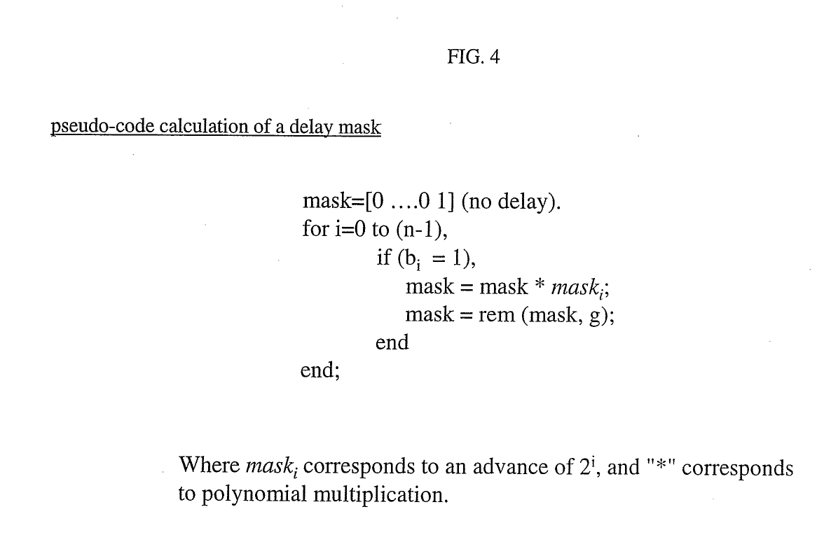

As a result of the above analysis, the sequence of operations required for calculation of an arbitrary delay mask can be described in a pseudo-code form as shown in FIG. 4, where the desired advance is represented by the binary word D, where D comprises n bits, b₀ to bₙ₋₁.

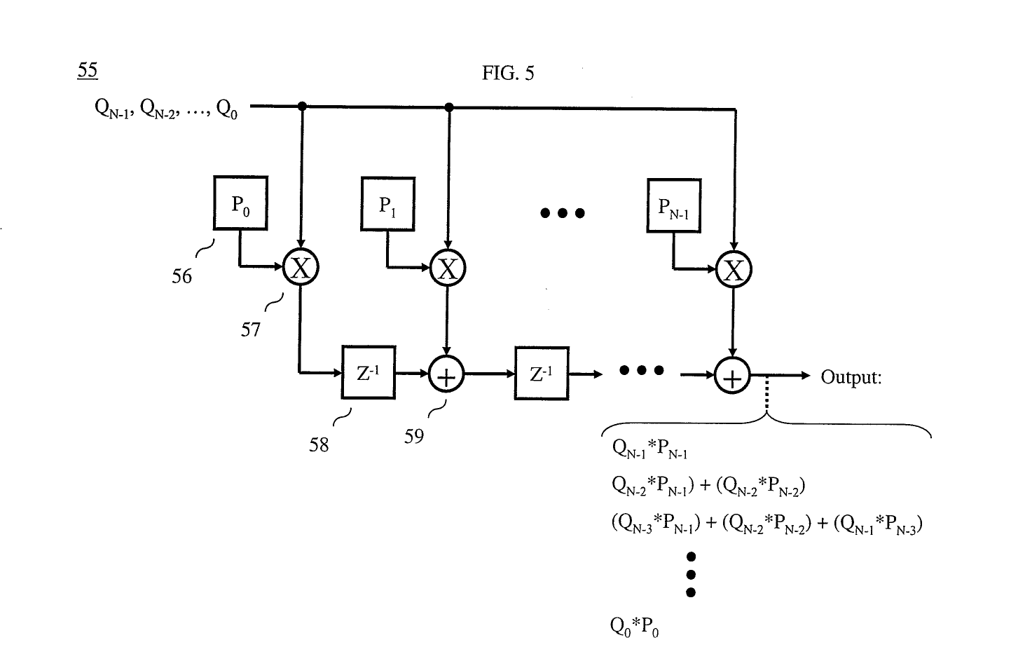

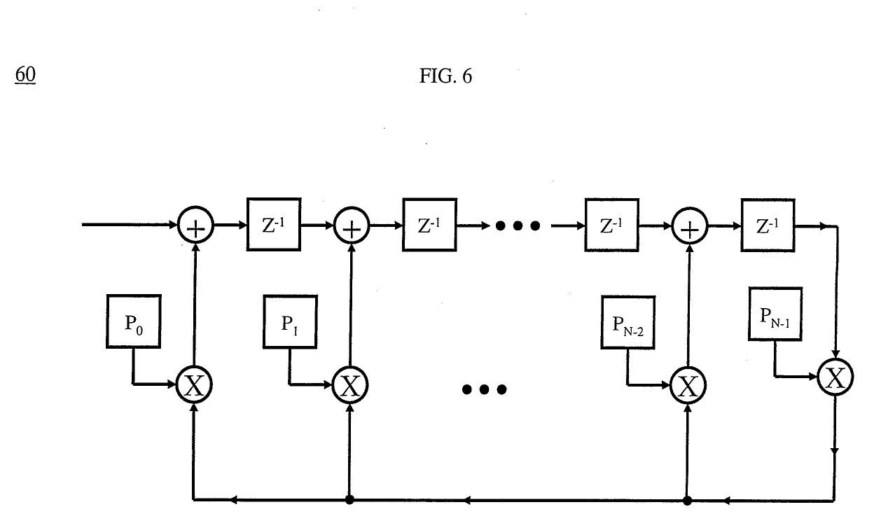

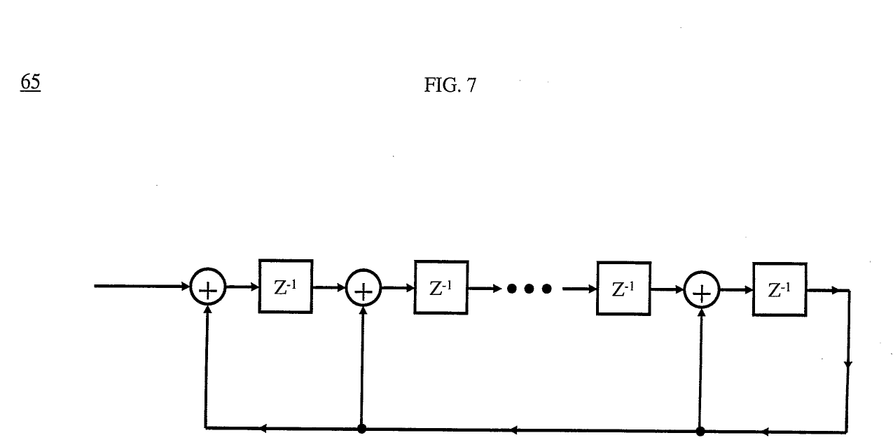

A corresponding hardware implementation of these functions is shown in FIGS. 5, 6 and 7. A polynomial multiplier 55 is shown in FIG. 5, a generic polynomial divider 60 is shown in FIG. 6, and a specific polynomial divider 65 is shown in FIG. 7. Using the arrangement shown in FIG. 5 as a reference for the elements of FIGS. 5, 6 and 7, element 56 represents the bit value of P₀ of the multi-bit word P; element 57 is a multiplier; element 58 is a delay element; and element 59 is an adder, etc. The generic polynomial divider 60 can be configured to divide by any polynomial by programming particular bit values for P (P₀, P₁, . . . P_{N-1}). However, if only one polynomial divisor is needed, it can be hard-wired into the structure, as illustrated by specific polynomial divider 65 of FIG. 7, which represents the polynomial x⁴+x³+x¹+1. It should be noted that no XOR operation is needed for the x² term, since that term is zero in the divisor polynomial. Since the output of polynomial multiplier 55 can start to clock into the polynomial divider (60 or 65) before the multiplication is finished, the number of clocks for the multiplication plus division is approximately the length of the delay mask. However, in the worst case, the binary representation of the advance for a delay mask to be generated is all ones. As a result, the multiplication plus division would have to be performed n bit times and the total number of clocks would be approximately n squared.

A described above, a delay mask can be calculated to advance a given scrambling code to correspond to a particular offset, or delay. In addition, and in accordance with the principles of the invention, a number of delay masks can be precalculated and stored in a receiver for reference to improve performance. For example, delay masks associated with the following binary advances are precalculated and stored for each x and y in the receiver:
advances of: 2⁰, 2¹, . . . , 2¹⁷;
an advance of (2¹⁷−38400);
an advance of 131072, and
an advance of (131072+2¹⁷−38400).

As a result, for the x generator (or x LFSR), only the following full calculations for the delay mask are required:
n+d;
n+d+131072;
n+d+(M−F); and
n+d+131072+(M−F).
   where, n is the number of the scrambling code as determined during the cell search operation and d represents the desired delay, or advance.

Similarly, for the y generator (or y LFSR), only the following full calculations for the delay mask are required:
d;
d+(M−F);
d+131072; and
d+131072+(M−F).

As can be observed from the above, full calculations for the delay mask are only needed for an:
advance n for generator x (just once for each code); and
advance d (for each delay) for x and y.

From these calculations and the precalculated delay masks, all the remaining delay mask calculations can be calculated as “short” calculations. In particular, with respect to the x generator:
n+d: only two delay masks are involved;
n+d+131072: only two delay masks are involved given (1);
n+d+(M−F): only two delay masks are involved given (1); and
n+d+131072+(M−F): only two delay masks are involved given (1).
   And with respect to the y generator:
d+(M−F): only two delay masks are involved;
d+131072: only two delay masks are involved; and
d+131072+(M−F): only two delay masks are involved.

Therefore, once the delay mask corresponding to a code number n is calculated, as advances change, two full delay mask calculations are needed plus seven short delay mask calculations, which, for a 3GPP system, are less than three full delay mask calculations. The estimated number of clocks required for a new advance is:

2*18*18+7*18=774 clocks.

If the receiver clock runs faster than the chip rate, e.g., eight times the chip rate, all the required delay masks would be calculated in roughly 100 chips or 25 microseconds, which is much less than one time slot of a radio frame.

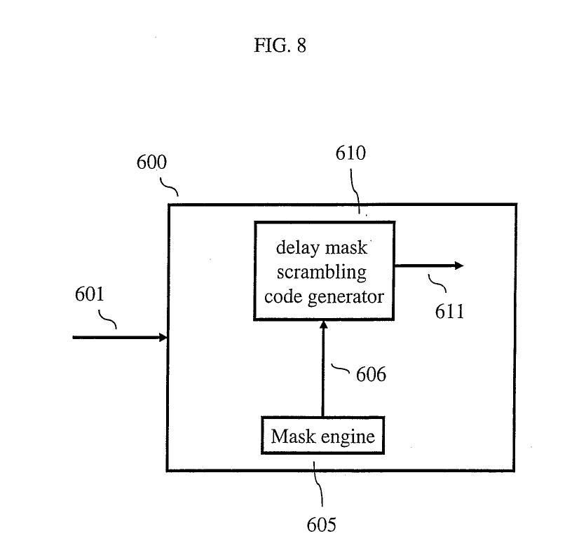

An illustrative wireless receiver 600 in accordance with the principles of the invention is shown in FIG. 8. Wireless receiver 600 is representative of any device capable of receiver a wireless signal (601), whether fixed or mobile, e.g., a cellular telephone, a personal digital assistant, a lap top personal computer (PC), a desk top PC, a dashboard mounted receiver in a car, etc. In accordance with the principles of the invention, wireless receiver 600 comprises a mask engine 605 for providing various delay masks (606) to delay mask scrambling code generator 605. The latter, responsive to the provided delay masks, provides scrambling codes with a particular offset, or delay (611).

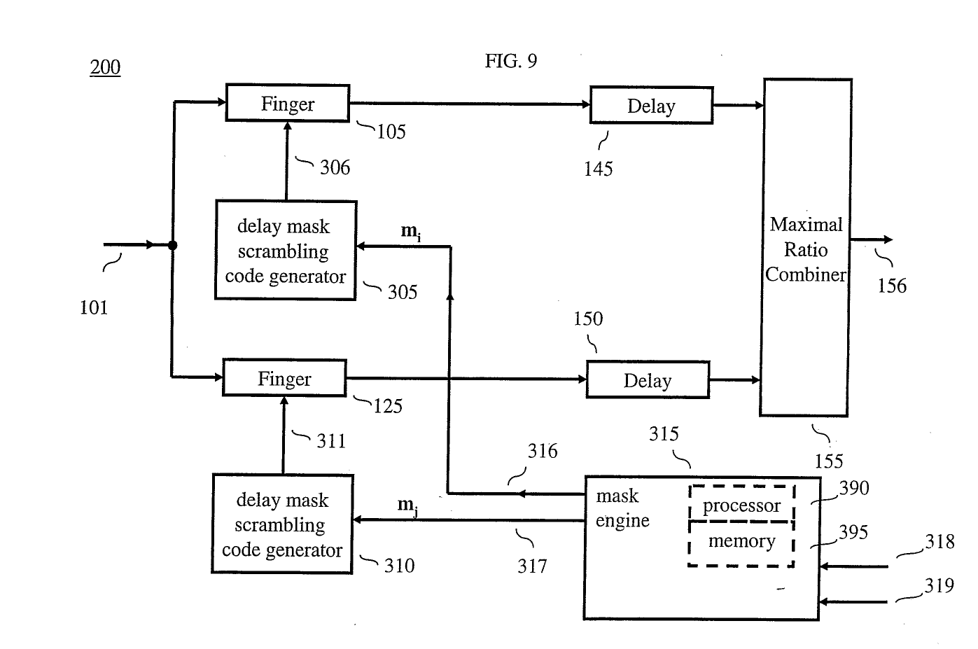

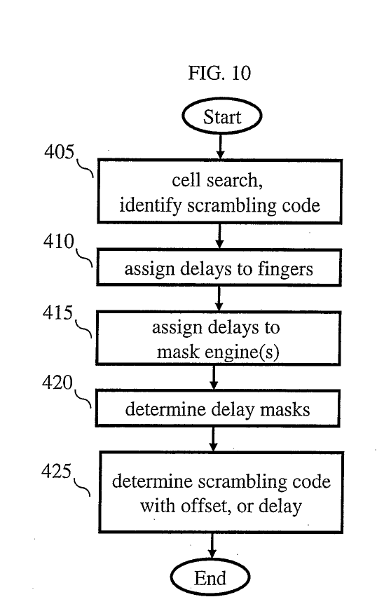

Turning now to FIG. 9, an illustrative embodiment of a portion 200 of a wireless receiver (such as wireless receiver 600 above) in accordance with the principles of the invention is shown. For this example, it is assumed that the wireless receiver is a 3GPP compatible receiver, e.g., a WCDMA receiver. Portion 200 comprises fingers 105 and 125, delay elements 145 and 150, maximal ratio combiner (MRC) 155, delay mask scrambling code generators 305 and 310, and mask engine 315. Reference at this time should also be made to FIG. 10, which shows an illustrative flow chart in accordance with the principles of the invention for use in the wireless receiver. In step 405 of FIG. 10, the wireless receiver performs the cell search operation and identifies the appropriate base station scrambling code. As noted earlier, multipath interference is combated by constructively adding outputs of fingers in a rake receiver to form a combined signal. In this regard, in step 410, the wireless receiver (e.g., the searcher element (not shown)) assigns delays to fingers 105 and 125 of FIG. 9. For purposes of illustration, only two fingers have been depicted in FIG. 9. However, the invention is not so limited. Other than the inventive concept, in step 410, each of the fingers 105 and 125 is assigned as known in the art to process a particular path of a received multipath signal 101 by using the relevant portion of the scrambling code, i.e., with the appropriate offset, or delay. In this regard, and in accordance with the principles of the invention, a delay mask scrambling code generator is used to provide the scrambling code with the appropriate delay. In particular, fingers 105 and 125 receive the appropriate value of the scrambling code from delay mask scrambling code generators 305 and 310, respectively. Each delay mask scrambling code generator provides the appropriately delayed scrambling code values by using a delay mask provided by mask engine 315. As such, in step 415 of FIG. 10, the wireless receiver (e.g., the search element) also provides the appropriate offsets, or delays, for the fingers to mask engine 315 via signals 318 and 319, which correspond to the delays for delay mask scrambling code generator 305 and 310, respectively. Mask engine 315 is a software-based controller as represented by processor 390 and memory 395 shown in the form of dashed boxes in FIG. 9. In this context, computer programs, or software, are stored in memory 395 for execution by processor 390. The latter is representative of one or more stored program control processors and these do not have to be dedicated to generating delay masks, e.g., processor 390 may also control other functions and or devices (not shown) of the wireless receiver. Memory 395 is representative of any storage device, e.g., random-access memory (RAM), read-only memory (ROM), etc.; and is volatile and/or non-volatile as necessary. In step 420 of FIG. 10, mask engine 315 provides the appropriate delay masks to the respective delay mask scrambling code generators. In particular, a delay mask mᵢ is provided to delay mask scrambling code generator 305 via signal 316; and a delay mask mⱼ is provided to delay mask scrambling code generator 310 via signal 317. In step 425, each delay mask scrambling code generator uses the provided delay mask to determine the scrambling code with the appropriate offset, or delay, and provide it to the requisite finger. Thus, as described above, each finger receives the appropriately offset, or delayed, version of the scrambling code for use in combating multi-path interference. The resulting signals provided by each finger are then aligned in time via delays 145 and 150 and processed by maximal ratio combiner (MRC) 155, which provides combined signal 156 for subsequent processing in the wireless receiver.

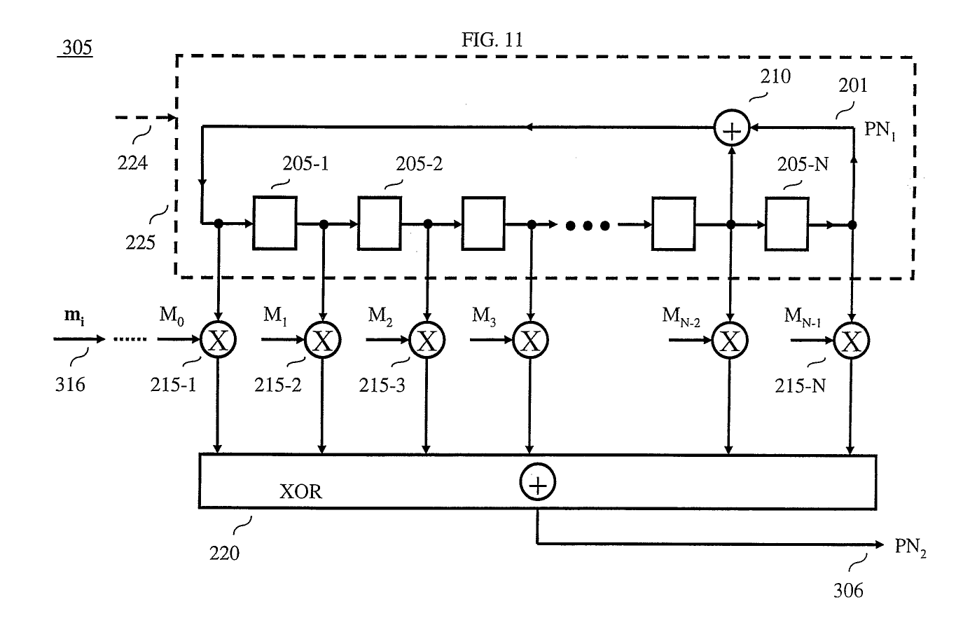

Turning now to FIG. 11, an illustrative embodiment of a delay mask scrambling code generator is shown and described in the context of delay mask scrambling code generator 305. Similar comments apply to delay mask scrambling code generator 310. In particular, the delay mask, mᵢ is a vector of N bits having the same length as PN generator 225, which comprises a number of delay elements 205-1, 205-2, . . . , 205-N and an adder 210. Other than the inventive concept, PN generator 225 is initialized to an initial state corresponding to the identified scrambling code as determined during the cell search operation. This is represented by dashed-line signal 224 of FIG. 11. The output of PN generator 225 is PN₁ via signal 201. Delay mask mᵢ is used to select (via a logical bitwise AND operation provided by multipliers 215-1, 215-2, 215-3, . . . , 215-N) particular bits from the current state of the PN generator 225; where the selected bits are then XORed by element 220 to provide output PN₂, via signal 306. In accordance with the principles of the invention, PN₂ represents the appropriately delay version of the scrambling code for use by finger 105.

As noted above, mask engine 315 provides the appropriate mask to the respective delay mask scrambling code generators. Mask engine 315 functions as described above in accordance with, e.g., equations (14), (15), (16) and (17), and FIGS. 4, 5, 6 and 7, etc. In the context of FIGS. 5, 6 and 7, it is assumed that mask engine 315 includes the software equivalents. However, this is not required and specific hardware may be included in mask engine 315. Further, Mask engine 315 may include pre calculated delay masks as noted above to reduce the calculation times.

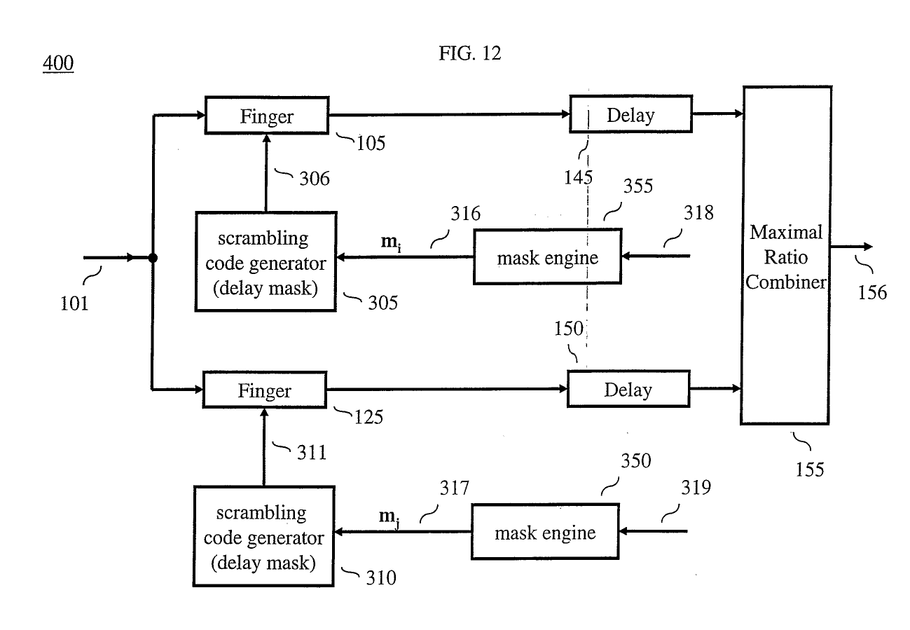

Another illustrative embodiment of a portion 400 of a wireless receiver in accordance with the principles of the invention is shown in FIG. 12. Portion 400 is similar to portion 200 of FIG. 9, except that each finger is associate with its own mask engine, as represented by mask engines 350 and 355. Mask engines 350 and 355 are similar to mask engine 315 of FIG. 9.

As described above, the inventive concept provides an alternative mechanism for determining scrambling code offsets in a wireless receiver. It should be noted that although shown as separate elements, a mask engine can be a part of another processor or implemented completely in hardware or be a part combination of hardware and software.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs) and/or in one or more stored program-controlled processors (e.g., a microprocessor or digital signal processor (DSP)). Similarly, although illustrated in the context of a UMTS-based system, the inventive concept is applicable to other communications system. It is therefore to be understood that numerous modifications may be made to the illustrative embodiments and that other arrangements may be devised without departing from the spirit and scope of the present invention as defined by the appended claims.

1. An apparatus comprising:
a mask engine for providing a delay mask associated with a delay; and
a scrambling code generator responsive to the delay mask for providing an offset version of a scrambling code, where the offset corresponds to the delay.

2. The apparatus of claim 1, further comprising:
a finger of a RAKE receiver, responsive to the offset version of the scrambling code for processing a multi-path received signal to provide an output signal;
wherein the delay is associated with one of the paths of the multi-path signal.

3. The apparatus of claim 1, wherein the scrambling code generator comprises:
a pseudo-noise generator having a length of N bits;
a selector responsive to the delay mask for selecting particular ones of the N bits; and
an element for performing an exclusive-or operation on the particular ones of the N bits to provide the offset scrambling code.

4. The apparatus of claim 1, wherein the mask engine comprises a memory for storing precalculated delay masks.

5. The apparatus of claim 4, wherein new delay masks are calculated from said precalculated delay masks.

6. The apparatus of claim 4, wherein new delay masks are calculated from said precalculated delay masks through the use of polynomial multiplication and division.

7. The apparatus of claim 1, wherein the apparatus is a part of a wide-band code division multiple access receiver.

8. A method for use in an apparatus, the method comprising:
determining delay masks associated with at least one identified delay; and
generating an offset scrambling code from each determined delay mask.

9. The method claim 8, further comprising the step of storing precalculated delay masks in a memory.

10. The method of claim 9, further comprising the step of calculating new delay masks from said stored precalculated delay masks.

11. The method of claim 10, wherein the calculating step uses polynomial multiplication and division.

12. A method for use in a receiver, the method comprising:
receiving a multi-path signal;
performing a cell search operation to identify a scrambling code used to transmit the multi-path signal;
identifying delays of the multi-path signal;
assigning the identified delays to a number of fingers of a RAKE receiver;
determining delay masks associated with each one of the identified delays; and
generating an offset scrambling code from each determined delay mask for use by the respective one of the number of fingers assigned to the identified delay.

13. The method of claim 12, wherein the generating step includes the steps of:
providing a pseudo-noise output;
filtering the pseudo-noise output with a determined delay mask to provide a filtered output; and
performing an exclusive-or operation on the filtered output to provided the offset scrambling code.

14. The method of claim 12, wherein the determining step includes the step of:
storing precalculated delay masks.

15. The method of claim 12, wherein the receiver is a wide-band code division multiple access receiver.
